(19) United States
(12) Patent Application Publication
(10) Pub. No.: US 2011/0016473 A1
(43) Pub. Date: Jan. 20, 2011

(54) MANAGING SERVICES FOR WORKLOADS IN VIRTUAL COMPUTING ENVIRONMENTS

(76) Inventor: Kattiganehalli Y. Srinivasan, Princeton Junction, NJ (US)

Correspondence Address: KING & SCHICKLI, PLLC, 247 NORTH BROADWAY, LEXINGTON, KY, 40507, US

(21) Appl. No.: 12/505,579

(22) Filed: Jul. 20, 2009

(51) Int. Cl. G06F 9/50

(52) U.S. Cl. 718/105

(57) ABSTRACT

Methods and apparatus involve managing computing services for workloads. A storage of services available to the workloads are maintained as virgin or golden computing images. By way of a predetermined policy, it is identified which of those services are necessary to support the workloads during use. Thereafter, the identified services are packaged together for deployment as virtual machines on a hardware platform to service the workloads. In certain embodiments, services include considerations for workload and service security, quality of service, deployment sequence, storage management, and hardware requirements necessary to support virtualization, to name a few. Meta data in open virtual machine formats (OVF) are also useful in defining these services. Computer program products and computing arrangement are also disclosed.

### FIELD OF THE INVENTION

Generally, the present invention relates to computing devices and environments involving computing workloads. Particularly, although not exclusively, it relates to providing services for the workloads, including services in a computing environment with virtual machines. Certain embodiments contemplate the packaging of services for deployment, while others contemplate packaging together the services for easy distribution as virtual machines. Still other features contemplate computing arrangements, policies, representative services, and computer program products, to name a few.

### BACKGROUND OF THE INVENTION

“Cloud computing” is fast becoming a viable computing model for both small and large enterprises. The “cloud” typifies a computing style in which dynamically scalable and often virtualized resources are provided as a service over the Internet. The term itself is a metaphor. As is known, the cloud infrastructure permits treating computing resources as utilities automatically provisioned on demand while the cost is strictly based on the actual resource consumption. Consumers of the resource also leverage technologies from the cloud that might not otherwise be available to them, in house, absent the cloud environment.

As with any new paradigm, considerable discussion is taking place on how best to utilize the environment. As one example, there has been recent interest in how best to leverage the public/private cloud infrastructure to augment the capabilities of a traditional enterprise data centers. As exists, conventional data centers are considered by some as an overlay of multiple disjointed workloads that simply happen to be hosted and managed by the enterprise IT department. In turn, each of these workloads have different requirements on security, performance, governance risk compliance (GrC), data management and quality of service (QoS), to name a few. Some are further distinguished by computing policies, access rights, or the like. Also, each workload corresponds to a set of physical machines with associated storage running the workload (the software stack). Workload specific services, such as auditing, are considered part of this stack and there exists a set of shared services for multiple workloads on a machine, such as domain name system (DNS), dynamic host configuration protocol (DHCP), firewall(s), identity and data management. The present packaging of services, however, ties too closely to the physical machine hosting the workloads. It also wastes capacity and increases management since some of the services may be replicated many times over per each physical machine in the cloud.

Accordingly, a need exists in the art of computing for better managing services for workloads. The need further contemplates a system that can package the services in a manner that maintains flexibility offered in virtual environments. Even more, the need should extend to leveraging the public/private cloud infrastructure to augment the capabilities of a traditional enterprise data center. Any improvements along such lines should further contemplate good engineering practices, such as simplicity, ease of implementation, unobtrusiveness, stability, etc.

### SUMMARY OF THE INVENTION

The foregoing and other problems become solved by applying the principles and teachings associated with the hereinafter-described management of services for workloads in a virtual computing environment. Broadly, methods and apparatus involve packaging together policy-specified computing services with those workloads requiring them and deploying same as virtual machine packages. Altogether, it can be considered an encapsulation of workloads as a “portable data center,” of sorts, that can be instantiated on any suitable hardware infrastructure. It now makes possible leveraging the cloud computing infrastructure as an extension of the enterprise data center. Furthermore, it is possible to relocate the encapsulated workloads on any available hardware infrastructure within the enterprise, thereby enhancing resource utilization within the enterprise without regard to the physical location of the resources. The proposed techniques also fit within disaster recovery schemes as well.

In one embodiment, a storage of services available to the workloads are maintained as virgin or golden computing images. (No longer do duplicitous servers need to individually retain their own version, which reduces overhead costs associated with storage capacities and requirements for computing devices.) By way of a predetermined policy, it is identified which of those services are necessary to support the workloads during use. Thereafter, the identified services are packaged together for deployment as virtual machines on a hardware platform to service the workloads. These services can be deployed any time to service the workloads, but may be “just-in-time” to address storage management issues faced by data centers. As such, it provides a balance to the overhead associated with storage capacities, and requirements for computing devices, and the speeds by which images can be deployed. In certain embodiments, services include considerations for workload and service security, quality of service, deployment sequence, storage management, and hardware requirements necessary to support virtualization, to name a few. Meta data in open virtual machine formats (OVF) are also useful in defining these services.

The foregoing may be used in conjunction with co-locating workloads together that have common security and isolation concerns. As such, the present invention references copending U.S. application Ser. No. 12/428,573, entitled “Securely Hosting Workloads in Virtual Computing Environments,” filed Apr. 23, 2009, the contents of which are incorporated herein as if fully set forth herein.

In accomplishing any of the foregoing, at least first and second computing devices have a hardware platform with a processor, memory and available storage upon which a plurality of virtual machines are configured under the scheduling control of a hypervisor. In turn, the virtual machines are shared or dedicated services to the workloads that are configured from the virgin computing images to service the workloads during use. The multiple services are packaged together according to a predetermined computing policy. In this manner, common services are easily and readily deployed.

Executable instructions loaded on one or more computing devices for undertaking the foregoing are also contemplated as are computer program products available as a download or on a computer readable medium. The computer program products are also available for installation on a network appliance or an individual computing device.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a basic computing device for hosting workloads and services:

FIG. 2 is a flow chart in accordance with the present invention for managing services for workloads in a virtual environment;

FIGS. 3-5 are diagrammatic views in accordance with the present invention of alternate embodiments for managing services for workloads; and

FIG. 6 is a diagrammatic view in accordance with the present invention of a data center environment for managing services for workloads.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for managing services for workloads in a virtual computing environment.

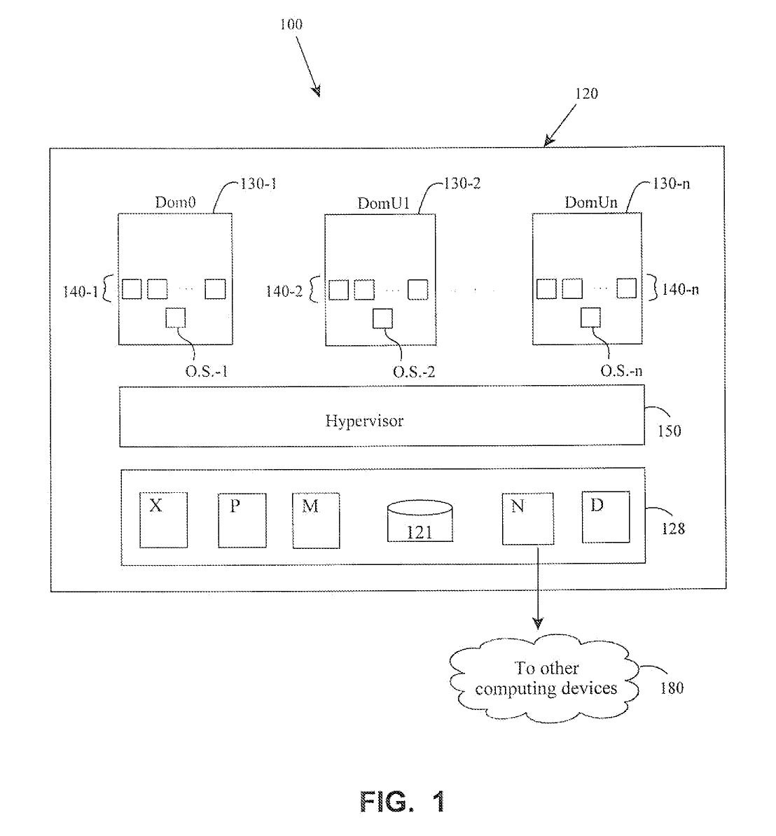

With reference to FIG. 1, a computing system environment 100 includes a computing device 120. Representatively, the device is a general or special purpose computer, a phone, a PDA, a server, a laptop, etc., having a hardware platform 128. The hardware platform includes physical I/O and platform devices, memory (M), access to remote or local storage drives 121, processor (P), such as a CPU(s), USB or other interfaces (X), drivers (D), etc. In turn, the hardware platform hosts one or more virtual machines in the form of domains 130-1 (domain 0, or management domain), 130-2 (domain U1), . . . 130-n (domain Un), each having its own guest operating system (O.S.) (e.g., Linux, Windows, Netware, Unix, etc.), applications 140-1, 140-2, . . . 140-n, file systems, etc.

An intervening Xen or other hypervisor layer 150, also known as a “virtual machine monitor,” or virtualization manager, serves as a virtual interface to the hardware and virtualizes the hardware. It is also the lowest and most privileged layer and performs scheduling control between the virtual machines as they task the resources of the hardware platform, e.g., memory, processor, storage, network (N) (by way of network interface cards, for example), etc. The hypervisor also manages conflicts, among other things, caused by operating system access to privileged machine instructions. The hypervisor can also be type 1 (native) or type 2 (hosted). According to various partitions, the operating systems, applications, application data, boot data, or other data, executable instructions, etc., of the machines are virtually stored on the resources of the hardware platform.

In use, the representative computing device 120 is arranged to communicate 180 with one or more other computing devices or networks. In this regard, the devices may use wired, wireless or combined connections to other devices/networks and may be direct or indirect connections. If direct, they typify connections within physical or network proximity (e.g., intranet). If indirect, they typify connections such as those found with the internet, satellites, radio transmissions, or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

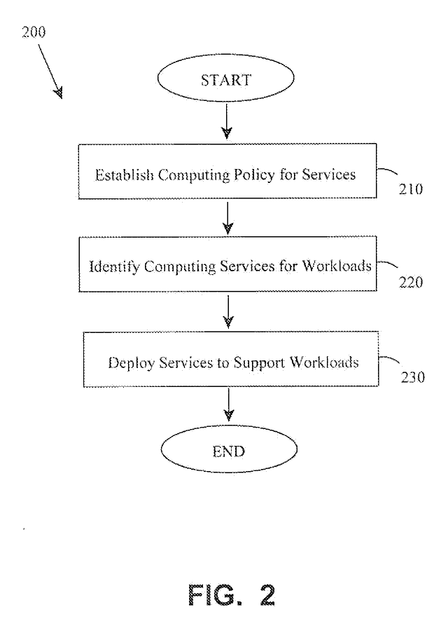

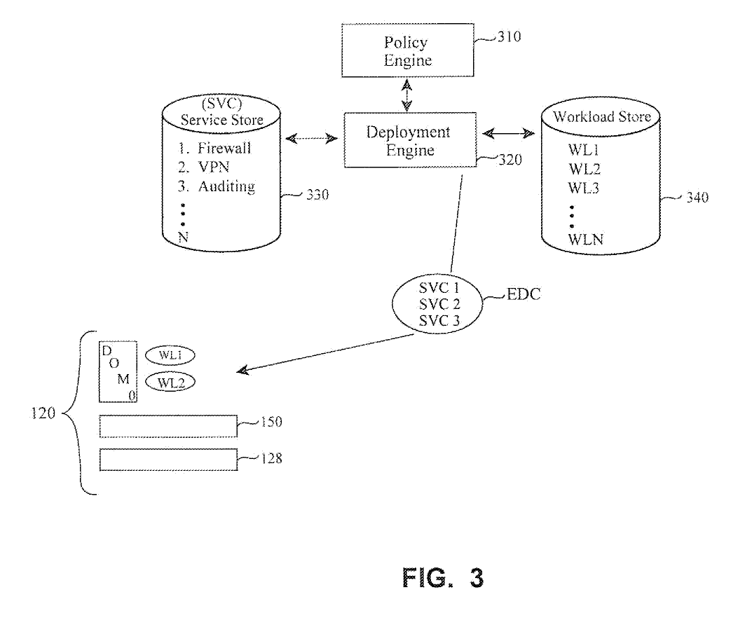

Leveraging the foregoing, FIG. 2 shows a methodology 200 for managing services. At step 210, a computing policy is first established for the services. This can be done at an enterprise level, division level, individual level, etc. It can include setting forth the computing situations in which certain services will be required. For instance, the policy may set forth firewall or other security settings as a function of which workloads are being used. The policies can further include defining which services require which workloads, and whether such is optional or required, edge, setting forth a financial based workload as requiring an auditing service, but setting forth a word processing workload as not needing the service or optionally making it available. Further still, policies may specify when and how long services are required. This can include establishing the time for instantiation of services, setting forth an expiration or renewal date, or the like. Policies may also include defining a quality of service for either the services or workloads and hardware platform requirements, such as device type, speed, storage, etc. These policies can also exist as part of a policy engine that communicates with other engines, such as a deployment engine, see FIGS. 3-5, when carrying out the policies. Skilled artisans can readily imagine other scenarios.

At step 220, the services are then tied to the workloads. In practice, this means identifying those services that will exist with actual workloads. In one instance, workload number one may require Firewall and VPN services, while workload number two may require Firewall and auditing services, and so on for all workloads (FIGS. 3-5). Such identification may be mapped in storage as well so that all workloads whether deployed or to-be-deployed will be easily identified as to what services are required.

Then, at step 230, the services identified in step 220 are packaged together and deployed for use with their respective workloads. During use, deployment of the packaged together services can occur before, after or during instantiation of the workloads. Deployment may also mean same or differentiated hardware platforms with the services being provided as virtual machines copied from golden or virgin images stored in the environment.

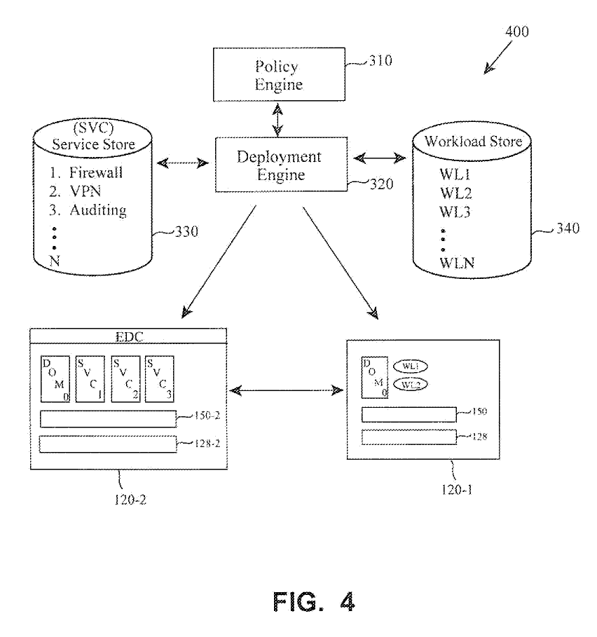

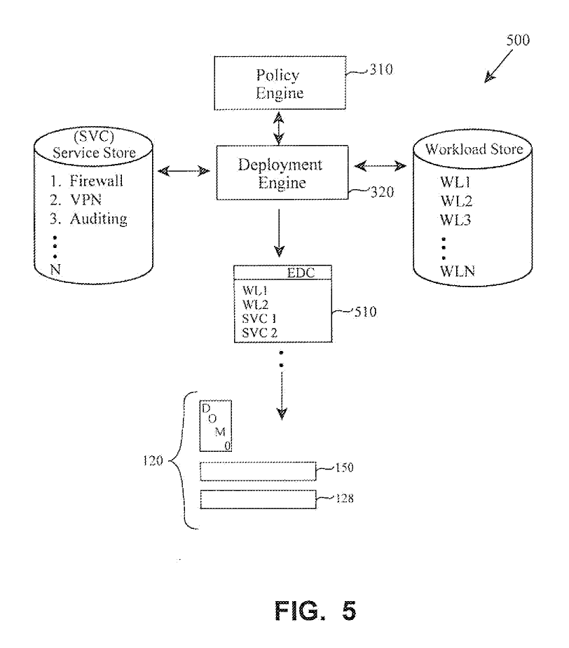

For example, FIG. 3 illustrates an environment 300 with a policy engine 310 in communication with a deployment engine 320. At 330, a store of golden images of the requisite services is provided as is a store 340 of workloads. Upon deployment of one or more workloads WL1, WL2, to a hardware platform 128, the requisite services for the workloads are encapsulated or packaged together (e.g., EDC for “encapsulated data center”) and provided to the same hardware platform 128 as virtual machines. During use, the virtual machines work in conjunction with a management domain (dom 0) and services the two workloads as seen. Alternatively, FIG. 4 shows an environment 400 where the services (e.g., SVC1, SVC 2, SVC 3) may be packaged together and deployed as virtual machines to a hardware platform 128-2 of a first computing device 120-2, while the workloads WL1. WL2, that they service are found on a separate hardware platform on a second computing device 120-1. Alternatively still. FIG. 5 shows an environment 500 where services SVC 1, SVC 2, are packaged together 510 with their workloads WL1, WL2 and such together is deployed to a common hardware platform 120. Of course, skilled artisans will appreciate that the services can be packaged in many ways and still accomplish the servicing of the workloads.

Also, the policy engine could exist together with the deployment engine or with any of the stores. Representative embodiments of other services available for encapsulation in an EDC include: a Firewall; DHCP services, structuring service to run an EDC in its own subnet (VLAN); DNS (proxy) services; Identity (proxy) services; storage management services, with these managing the effective placement of data by managing the migration of data into and out of the EDC; availability management services, with service to monitor and guarantee availability of both services comprising the workload as well as other infrastructure services; performance and quality of service management services; a sequencer service to boot the services in the EDC in a specified order; deployment engine services to interface with the infrastructure provider of the cloud and to instantiate both the workload as well as other infrastructure services; VPN services to provide EDC clients with a secure tunnel, to name a few. In addition to the set of services encapsulated in the EDC, additional state services that control deployment decisions will be embedded as part of the EDC. For this, skilled artisans will note that OVF allows annotating virtual machines with additional meta data. Representative additions include: a security label to control if the EDC can share hardware resources with other workloads, see earlier application incorporated by reference; hardware resource requirements to service storage, processing and I/O; and quality of service (QOS) metric services.

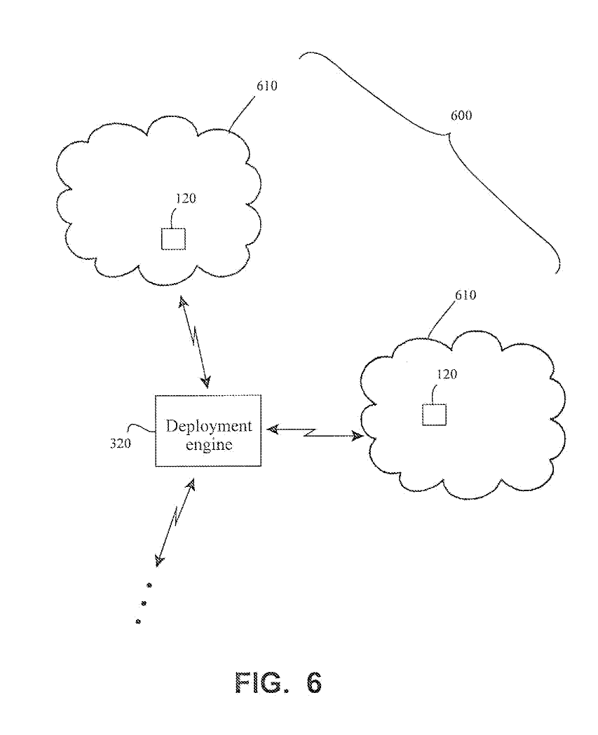

With reference to FIG. 6, the features of the invention can be replicated many times over in a larger computing environment 600, such as a “cloud” environment or a large enterprise environment. For instance, multiple data centers 610 could exist that are each connected by way of a deployment engine 320. In turn, each data center could include individual computing devices 120 and their attendant structures in order to provide packaged services to workloads. In turn, the computing policies 210, FIG. 2, could be centrally managed by the engine and could further include scaling to account for competing interests between the individual data centers. Other policies could also exist that harmonize the events of the data centers. Alternatively still, each data center could have its own deployment engine. Nested hierarchies of all could further exist.

In still other embodiments, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of the other figures.

1. In a computing system environment, a method of managing services for workloads of computing devices having hardware platforms, comprising:
maintaining a storage of services available to the workloads, each of the services being a virgin computing image stored on a computing storage device;
identifying which of the services are required for the workloads; and
packaging together the identified services for deployment as virtual machines on a hardware platform to service the workloads during use.

2. The method of claim 1, further including deploying each of the identified services as a single virtual machine.

3. The method of claim 2, further including deploying the each of the identified services on a common hardware platform.

4. The method of claim 1 further including establishing a computing policy for the services.

5. The method of claim 1, further including providing a deployment engine as one of the identified services to interface with a provider of cloud computing services.

6. The method of claim 1, further including providing a sequencer as one of the identified services to boot each of the identified services in a specified order.

7. The method of claim 1, further including providing a monitor as one of the identified services to guarantee availability of the identified services.

8. In a computing system environment, a method of managing services for workloads of computing devices having hardware platforms, comprising:
maintaining a storage of services available to the workloads, each of the services being a virgin computing image stored on a computing storage device;
identifying which of the services are required for the workloads;
packaging together the identified services; and
deploying the packaged together identified services as virtual machines on a hardware platform to service the workloads during use.

9. The method of claim 8, wherein the identifying which of the services are required for the workloads includes examining a computing policy of an enterprise defining quality of service, security and hardware necessary for the deploying the virtual machines.

10. The method of claim 8, wherein the computing system environment includes a cloud environment interfacing with a data center of an enterprise, further including providing a deployment engine as one of the identified services to interface with a provider of the cloud environment.

11. The method of claim 10, further including embedding meta data into an open virtual machine format of the virtual machines identifying deployment decisions for the deployment engine.

12. The method of claim 9, further including mapping the services available to the workloads to the computing policy.

13. A computing system to manage services for workloads of computing devices having hardware platforms, comprising:
at least first and second computing devices each with a hardware platform having at least a processor, memory and available storage upon which a plurality of virtual machines are configured under the scheduling control of a hypervisor, wherein the plurality of virtual machines are multiple services configured from virgin computing images to service the workloads during use, the multiple services being packaged together to said service the workloads according to a predetermined computing policy.

14. The system of claim 13, further including a deployment engine on a hardware platform configured to read meta data of the virtual machines in an open virtual machine format to make deployment decisions for the multiple services.

15. The system of claim 14, further including a computing storage device for storing the virgin computing images, the computing storage device and the deployment engine being in communication.

16. The system of claim 13, further including a cloud computing service in communication with the deployment engine.

17. A computer program product for loading on a computing device to manage services for workloads on a same or different computing device, comprising executable instructions to identify which of a plurality of services are required to service the workloads during use and to package together the identified services as virtual machines for deployment to said same or different computing device.

18. The computer program product of claim 17, further including executable instructions to configure a deployment engine on said same or different computing device to read meta data of the virtual machines in an open virtual machine format to make deployment decisions for the plurality of services.

19. The computer program product of claim 17, further including executable instructions for ascertaining a quality of service metric, a security label and a hardware resource requirement for said deployment of the virtual machines.

20. The computer program product of claim 17, further including executable instructions to configure a sequencer as one of the identified services to boot each of the identified services in a specified order.
